(19) United States
(12) Patent Application Publication
(10) Pub. No.: US 2024/0083239 A1
(43) Pub. Date: Mar. 14, 2024

(54) HUB ELECTRIC MOTOR

(71) Applicant: CHUZHOU BETTYMA BABY CARRIER CO., LTD., Chuzhou City, Anhui (CN)

(72) Inventors: Dajun XU, Chuzhou City (CN); Wujun ZHU, Chuzhou City (CN)

(73) Assignee: CHUZHOU BETTYMA BABY CARRIER CO., LTD., Chuzhou City, Anhui (CN)

(21) Appl. No.: 18/274,378

(22) PCT Filed: Apr. 7, 2022
(86) PCT No.: PCT/CN2022/085448

§ 371 Date: Jul. 26, 2023

(30) Foreign Application Priority Data
Jan. 6, 2022 (CN) 202220019239.3

(51) Int. Cl. B60K 7/00; H02K 7/116

(52) U.S. Cl. CPC B60K 7/0007; H02K 7/116; B60K 2007/0061

(57) ABSTRACT

Disclosed in the present utility model is a hub electric motor, comprising a hub, wherein the hub comprises an inner side cover and an outer side cover, a wheel shaft penetrates the axis positions of the inner side cover and the outer side cover, one end of the wheel shaft is fixed to the inner side cover, and the other end of the wheel shaft is located in a wheel shaft hole of the outer side cover: the inner side cover is fixed to a vehicle body, and the outer side cover can rotate around the wheel shaft. The hub electric motor further comprises an electric motor, wherein the electric motor is fixed to a left side cover, an electric motor shaft extends into the hub, and the electric motor shaft is fixedly provided with an electric motor gear, and the hub is internally provided with a gear transmission mechanism, wherein the electric motor gear drives the outer side cover to rotate by means of the gear transmission mechanism, and the electric motor is fixed to a position that deviates from an axis of the wheel shaft. By means of this configuration. the gear transmission mechanism is used for driving the outer side cover to rotate. so that the electric motor can be conveniently fixed to the position that deviates from the axis of the wheel shaft, the diameter of the electric motor gear can be adjusted according to requirements, and the positions of all the accessories can be rationally arranged.

### TECHNICAL FIELD

The utility model relates to a hub electric motor, which belongs to the electric trolley.

### BACKGROUND TECHNOLOGY

The hub is the rotating part of the wheel core connected by the inner profile steel of the tire through a column. The hub electric motor is a motor system designed to integrate the power system and transmission system of the car. In the existing hub electric motor on the market, the motor is installed in a coaxial position with the wheel shaft, which is easy to reduce the strength of the wheel shaft and is not convenient to arrange the location of various accessories reasonably.

### SUMMARY OF THE INVENTION

### Technical Problems

The coaxial installation of the motor and the axle is easy to reduce the strength of the axle, and it is not convenient to arrange the position of the accessories reasonably.

### Utility Model Content

In view of the shortcomings of the prior art, the utility model provides a hub electric motor which is fixed to a position that deviates from an axis of the wheel shaft.

For the above purpose, the utility model provides the following technical solutions: a hub electric motor, comprising a hub. wherein the hub comprises an inner side cover and an outer side cover, a wheel shaft penetrates the axis positions of the inner side cover and the outer side cover, one end of the wheel shaft is fixed to the inner side cover and the other end of the wheel shaft is located in a wheel shaft hole of the outer side cover; the inner side cover is fixed to a vehicle body, and the outer side cover can rotate around the wheel shaft. The hub electric motor further comprises an electric motor, wherein the electric motor is fixed to a left side cover, an electric motor shaft extends into the hub, and the electric motor shaft is fixedly provided with an electric motor gear and the hub is internally provided with a gear transmission mechanism, wherein the electric motor gear drives the outer side cover to rotate by means of the gear transmission mechanism and the electric motor is fixed to a position that deviates from an axis of the wheel shaft.

By means of this configuration the gear transmission mechanism is used for driving the outer side cover to rotate so that the electric motor can be conveniently fixed to the position that deviates from the axis of the wheel shaft, the diameter of the electric motor gear can be adjusted according to requirements, and the positions of all the accessories can be rationally arranged.

The utility model is further provided that the motor is fixed on the left side cover through the motor fixing sleeve, and the motor fixing sleeve is a shell suitable for the shape of the motor; the motor fixing sleeve is provided for the installation of the motor.

The utility model is further provided that the gear transmission mechanism comprises a two-stage gear meshing with the electric motor gear. The two-stage gear comprises a two-stage wheel and a two-stage pinion coaxial arranged. The two-stage gear sleeve is arranged on the wheel shaft. The two-stage gear is installed between the two-stage gear and the wheel shaft bearing. And the two-stage wheel is meshed with the electric motor gear; the electric motor gear is meshed with the two-stage wheel so that the motor with high speed and low torque is converted to the rotation of low speed and high torque.

The utility model is further provided that the gear transmission mechanism comprises a three-stage gear meshing with the two-stage pinion. The three-stage gear comprises a three-stage wheel and a two-stage pinion, and the three-stage wheel meshing with the two-stage pinion; the motor with high speed and low torque is converted to the rotation of low speed and high torque by using this setting.

The utility model is further provided that the left side cover is fixed with a three-stage gear support frame. The three-stage gear support frame is equipped with a three-stage gear cover. The three-stage gear support frame is an upward groove, and the outer wall of the three-stage gear support frame is in the shape of a step. The three-stage gear cover is fixed with a three-stage gear shaft, and the three-stage gear rotation is installed on the three-stage gear shaft; the three-stage gear support frame and the three-stage gear cover are easy to install the three-stage gear.

The utility model is further provided that three three-stage gears are arranged, and the three-stage gears are evenly distributed in the center of the wheel shaft.

The utility model is further provided that the three-stage gear cover is fixed to the three-stage gear support frame by screws, and the three-stage gear support frame is provided with a three-stage gear rotating shaft mounting hole.

The utility model is further provided that the transmission gear mechanism also includes a four-stage gear, which includes the four-stage meshing gear engaging with the three-stage pinion and the plum type gear which is coaxial with the four-stage meshing gear. The four-stage gear is rotated and mounted on the wheel shaft, a bearing is provided between the four-stage gear and the wheel shaft, and the right side cover is provided with a plum groove cooperating with the plum type gear. The setting of the plum blossom groove allows the right side cover to be linked with the plum type gear, and the transmission mechanism drives the right side cover to rotate.

The utility model is further provided that the three-stage gear support frame is equipped with an outer bearing installation surface. The three-stage gear support frame is composed of a plurality of rings with different diameters, and the outer surface of the ring with different diameters is connected in the shape of a step. The side of the ring with a smaller diameter forms an outer bearing installation surface, the lower end face of the outer bearing is pressed against the step, and the inner side of the right side cover is pressed against the outer bearing installation surface. The outer bearing is arranged to reduce the resistance of the right side cover when it is turned.

The utility model is further provided that the left side cover is provided with a ring bump toward the right side cover. The right side cover is provided with a ring groove, and the right side cover is fixed with a tire.

### Beneficial Effects of the Invention

By means of this configuration the gear transmission mechanism is used for driving the outer side cover to rotate so that the electric motor can be conveniently fixed to the position that deviates from the axis of the wheel shaft, the diameter of the electric motor gear can be adjusted according to requirements, and the positions of all the accessories can be rationally arranged.

### DESCRIPTION OF ATTACHED DRAWINGS

FIG. 1 is a structural diagram of the hub electric motor of the utility model.

FIG. 2 is an explosion diagram of the hub electric motor of the utility model.

FIG. 3 is an explosion diagram of the hub electric motor of the utility model.

FIG. 4 is a sectional view of the hub electric motor of the utility model.

Figure: 1. Hub; 11. Left side cover; 12. Right side cover; 121. Tire; 13. Outer bearing; 2. Electric motor; 21. Motor shaft; 22. Electric motor gear; 23. Motor fixing sleeve; 3. Wheel shaft; 4. Two-stage gear; 41. Two-stage wheel; 42. Two-stage pinion; 5. Three-stage gear; 51. Three-stage wheel; 52. Three-stage pinion; 53. Three-stage gear support frame; 54. Three-stage gear cover; 55. Three-stage gear shaft; 56. Outer bearing installation surface; 6. Four-stage gear; 61. Four-stage meshing gear; 62. Plum type gear.

### Implementation Method

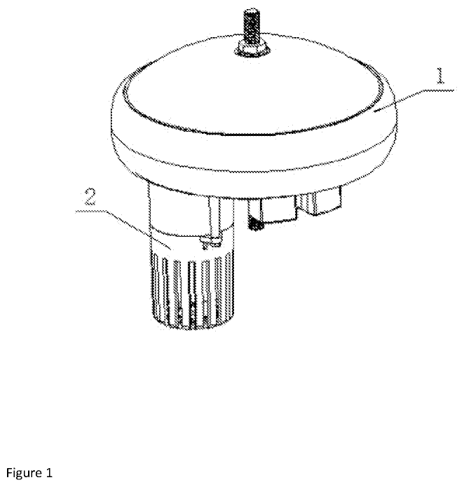

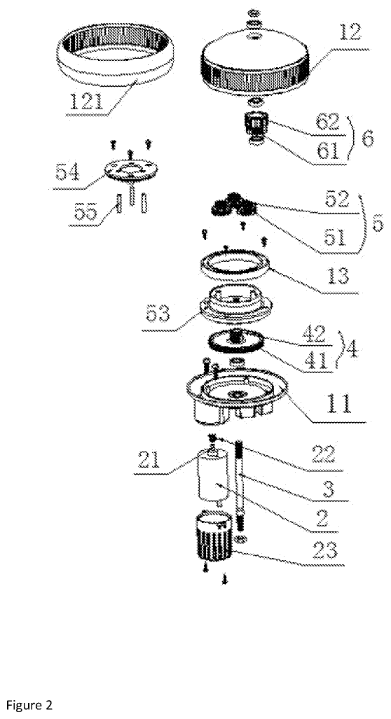

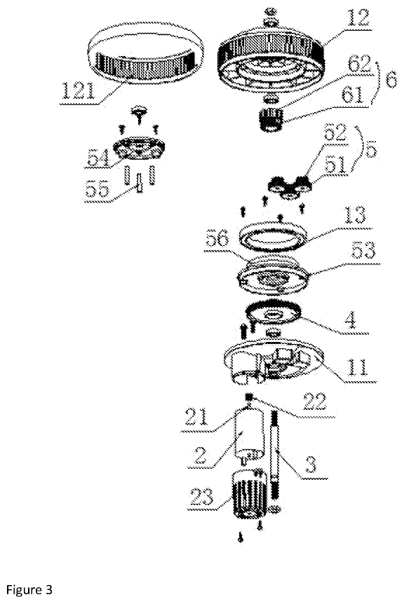

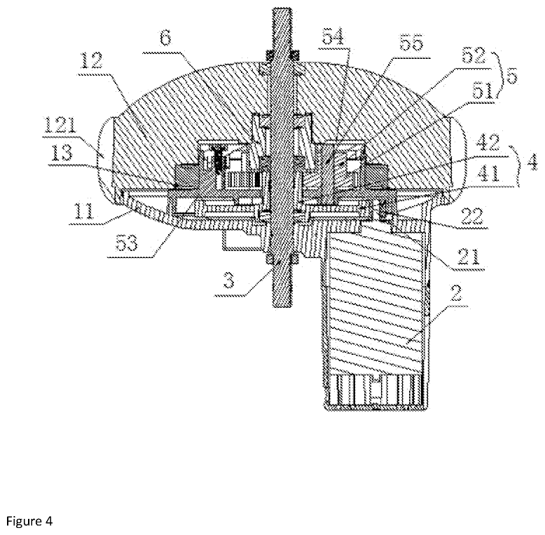

The embodiments of a hub electric motor of the utility model are further explained in the following FIGS. 1 to 4.

A hub electric motor, comprising a hub 1, wherein the hub 1 comprises an inner side cover and an outer side cover, a wheel shaft 3 penetrates the axis positions of the inner side cover and the outer side cover, one end of the wheel shaft 3 is fixed to the inner side cover and the other end of the wheel shaft is located in a wheel shaft hole of the outer side cover; the inner side cover is fixed to a vehicle body, and the outer side cover can rotate around the wheel shaft 3. Preferably, the wheel shaft 3 and the inner side cover are fixed together by a coating process.

The hub electric motor further comprises an electric motor 2, wherein the electric motor is fixed to a left side cover 11 through the motor fixing sleeve 23, an electric motor shaft 21 extends into the hub, and the electric motor shaft 21 is fixedly provided with an electric motor gear 22. The motor fixing sleeve 23 is a shell adapted to the shape of the motor 2, and the motor fixing sleeve 23 is fixed on the left side cover 11 by screws; as a preferred option, the interference fit between the electric motor gear 22 and the motor shaft 21.

The hub 1 is provided with a two-stage gear 4 meshing with the electric motor gear 22. The two-stage gear 4 includes the coaxial setting of the two-stage wheel 41 and the two-stage pinion 42.

The two-stage gear 4 is set on the wheel shaft 3. The bearing is installed between the two-stage gear 4 and the wheel shaft 3. The above-mentioned the two-stage wheel 41 is matched with the electric motor gear 22. The hub 1 is also equipped with a three-stage gear 5 which includes a three-stage wheel 51 and a three-stage pinion 52. The three-stage wheel 51 engages with the two-stage pinion 42. The left side cover 11 is fixed with a three-stage gear support frame 53 which is provided with a three-stage gear cover 54. The three-stage gear support frame 53 is an upward groove, and the outer wall of the three-stage gear support frame 53 is in the shape of a step. The three-stage gear cover 54 is screwed to the three-stage gear support frame 53. The three gear pressure cover 54 is fixed to the three-stage gear shaft 55. The three-stage gear 5 is mounted on the three-stage gear shaft 55. Three three-stage gears 5 are arranged, and the three-stage gears 5 are evenly distributed in the center of the wheel shaft 3. Preferably, the glue wrapping process is used between the three-stage gear shaft 55 and the three-stage gear cover 54. The three-stage gear support frame 53 is provided with a three-stage gear shaft 55 mounting hole.

The hub 1 also includes a four-stage gear 6, which includes the four-stage meshing gear 52 engaging with the three-stage pinion 52 and the plum type gear 62 which is coaxial with the four-stage meshing gear 61. The four-stage gear 6 is rotated and mounted on the wheel shaft 3, a bearing is provided between the four-stage gear 6 and the wheel shaft 3, and the right side cover 12 is provided with a plum groove cooperating with the plum type gear 62.

The three-stage gear support frame 53 is equipped with an outer bearing 13. The three-stage gear support frame 53 is composed of a plurality of rings with different diameters, and the outer surface of the ring with different diameters is connected in the shape of a step. The side of the ring with a smaller diameter forms an outer bearing installation surface 56, the lower end face of the outer bearing 13 is pressed against the step, and the inner side of the right side cover 12 is pressed against the outer bearing installation surface 56. The left side cover 11 is provided with a ring bump toward the right side cover 12. The right side cover 12 is provided with a ring groove, and the right side cover 12 is fixed with a tire 121.

The right side cover 12 and the left side cover 11 extend upwardly with a support portion against the wheel shaft 3.

When in use, the motor shaft 21 rotates to drive the electric motor gear 22 fixed on the motor shaft 21 to rotate. The electric motor gear 22 meshes with the two-stage wheel 41, so that the two-stage gear 4 rotates as a whole. The two-stage pinion 42 meshes with the three-stage wheel 51, so as to drive the three-stage gear 5 rotates as a whole. The three-stage pinion 52 meshes with the four-stage meshing gear 61, thus driving the four-stage gear 6 as a whole rotation, and then making the plum type gear 62 rotation. The right side cover 12 is provided with the plum type gear 62 matched with the plum gear groove. The rotation of the plum type gear 62 can drive the right side cover 12 to rotate; This application sets up multi-stage gear transmission, which decelerates the motor with higher rotational speed through multi-stage reduction gears, achieving the goal of driving the wheels of the electric baby bike with low speed and high torque.

The above are only the preferred embodiments of the utility model. The protection scope of the utility model is not limited to the above embodiments, and all the technical solutions under the utility model belong to the protection scope of the utility model. It should be noted that for ordinary technicians in the technical field, several improvements and embellishment without departing from the principle of the utility model shall also be regarded as the protection scope of the utility model.

### INDUSTRIAL APPLICABILITY

The application is used for electric stroller and is industrially practical.

1. A hub electric motor, comprising a hub (1), wherein the hub (1) comprises an inner side cover and an outer side cover, a wheel shaft (3) penetrates the axis positions of the inner side cover and the outer side cover, one end of the wheel shaft is fixed to the inner side cover and the other end of the wheel shaft (3) is located in a wheel shaft hole of the outer side cover; the inner side cover is fixed to a vehicle body, and the outer side cover can rotate around the wheel shaft (3). The hub electric motor further comprises an electric motor (2), wherein the electric motor is fixed to a left side cover (11), an electric motor shaft (21) extends into the hub, and the electric motor shaft (21) is fixedly provided with an electric motor gear (22) and the hub is internally provided with a gear transmission mechanism, wherein the electric motor gear (22) drives the outer side cover to rotate by means of the gear transmission mechanism and the electric motor (2) is fixed to a position that deviates from an axis of the wheel shaft (3).

2. The hub electric motor according to claim 1, characterized in that, the motor (2) is fixed to the left side cover (11) by the motor fixing sleeve (23), which (23) is a housing adapted to the shape of the motor (2).

3. The hub electric motor according to claim 1, characterized in that, the gear mechanism comprises a secondary gear (4) engaging with the electric motor gear (22). The secondary gear (4) comprises a gear (41) and a secondary pinion (42). The secondary gear (4) is set on the wheel shaft (3). The secondary gear (4) and the wheel shaft (3) is installed between the bearing, and the secondary gear (41) engaging with the electric motor gear (22).

4. The hub electric motor according to claim 3, characterized in that, the gear transmission mechanism further comprises a three-stage gear (5) engaged with the secondary pinion (42), the three-stage gear (5) comprising a three-stage wheel (51) and a three-stage pinion (52), and the three-stage wheel (51) engages with the secondary pinion (42).

5. The hub electric motor according to claim 4, characterized in that, the left side cover (11) is fixed with a three-stage gear support frame (53). And the three-stage gear support frame (53) has a three-stage gear cover (54). The three-stage gear support frame (53) is an open upward groove, and the outer side wall of the three-stage gear support frame (53) is shaped like a step. The three-stage gear cover (54) is fixed with a three-stage gear shaft (55), and the three-stage gear (5) is rotated and mounted on the three-stage gear shaft (55).

6. The hub electric motor according to claim 5, characterized in that, the three-stage gears (5) are provided with three. And the three-stage gears (5) are evenly distributed around the wheel shaft (3).

7. The hub electric motor according to claim 6, characterized in that, the three-stage gear cover (54) is screwed to a three-stage gear support frame (53) and the three-stage gear support frame (53) has a three-stage gear shaft (55) mounting hole.

8. The hub electric motor according to claim 7, characterized in that, the gear transmission mechanism further comprises a four-stage gear (6). The four-stage gear (6) comprises a four-stage meshing gear (61) engaging with the three-stage pinion (52) and a plum type gear (62) engaging with the four-stage meshing gear (61). The four-stage gear (6) rotates and is installed on the wheel shaft (3). The four-stage gear (6) and the wheel shaft (3) is provided with a bearing, and the right side cover (12) has a plum groove mating with the plum type gear (62).

9. The hub electric motor according to claim 8, characterized in that, the three-stage gear support frame (53) is equipped with an outer bearing installation surface (56). The three-stage gear support frame (53) is composed of a plurality of rings with different diameters, and the outer surface of the ring with different diameters is connected in the shape of a step. The side of the ring with a smaller diameter forms an outer bearing installation surface (56), the lower end face of the outer bearing installation surface (56) is pressed against the step, and the inner side of the right side cover (12) is pressed against the outer bearing installation surface (56).

10. The hub electric motor according to claim 9, wherein the left side cover (11) is provided with a ring bump toward the right side cover (12). The right side cover (12) is provided with a ring groove, and the right side cover (12) is fixed with a tire (121).
